(19) United States
(12) Patent Application Publication
(10) Pub. No.: US 2022/0357738 A1
(43) Pub. Date: Nov. 10, 2022

(54) REMOTE ASSISTANCE MANAGEMENT SYSTEM, REMOTE ASSISTANCE MANAGEMENT METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventors: Yoshitaka ADACHI, Koto-city (JP); Kentaro ICHIKAWA, Sunto-gun (JP); Koji TAGUCHI, Sagamihara-shi (JP); Maiko HIRANO, Nagoya-shi (JP)

(73) Assignee: TOYOTA JIDOSHA KABUSHIKI KAISHA, Toyota-shi (JP)

(21) Appl. No.: 17/722,690

(22) Filed: Apr. 18, 2022

(30) Foreign Application Priority Data
May 7, 2021 (JP) 2021-079312

(51) Int. Cl. G05D 1/00; B60W 60/00

(52) U.S. Cl. CPC G05D 1/0027; B60W 60/001; B60W 2556/45

(57) ABSTRACT

A remote assistance management system is in communication with a plurality of autonomous traveling vehicles for letting an operator provide remote assistance in response to an assistance request from a vehicle. The system predicts, for each vehicle, an occurrence of an assistance request in future based on an operation state of each vehicle and calculates a predicted assistance period for each assistance request predicted to occur. When more than a predetermined number of overlapping assistance requests of which predicted assistance periods overlap at the same time are predicted to occur, the system instructs to excess vehicles a change of a traveling mode from a first traveling mode being a normal traveling mode to a second traveling mode for avoiding or delaying the occurrence of an assistance request, the excess vehicles being vehicles in excess of the predetermined number among vehicles from which the overlapping assistance requests are predicted to occur.

### CROSS-REFERENCE TO RELATED APPLICATION

The present application claims priority under 35 U.S.C. § 119 to Japanese Patent Application No. 2021-079312, filed May 7, 2021, the contents of which application are incorporated herein by reference in their entirety.

### BACKGROUND

### Field

The present disclosure relates to a remote assistance management technique in communication with a plurality of autonomous traveling vehicles for letting an operator provide remote assistance in response to an assistance request from an autonomous traveling vehicle.

### Background Art

An autonomous traveling vehicle continues traveling autonomously. However, there are cases where autonomous determination of the autonomous traveling vehicle is uncertain or more sure safety determination is required. Therefore, rather than leaving everything to the autonomous determination of the autonomous traveling vehicle, assisting the autonomous traveling of the autonomous traveling vehicle by an operator has been considered. In the assisting, the operator is required to monitor the autonomous traveling vehicle remotely and, if necessary, transmit the determination and remote driving instruction to the vehicle. One of prior arts related to such a remote assistance management system is disclosed in JP2019-185279A.

The prior art disclosed in JP2019-185279A is a proposal on how to assign an operator to an autonomous traveling vehicle requiring remote assistance. In the prior art, handling order is determined based on task time required for the remote assistance and priority of the remote assistance, and then, the remote assistance is assigned to the operator in accordance with the handling order. This prevents vehicles requiring the remote assistance from obstructing traffic, and facilitates the traffic as a whole autonomous traveling system.

Thus, in the remote assistance management system, the role of the operator to remotely monitor and operate the autonomous traveling vehicle is important. If a thorough system that can respond promptly to assistance requests from autonomous traveling vehicles is necessary, the greater the number of operators relative to the total number of autonomous traveling vehicles, the better.

However, the greater the number of operators, the higher the personnel costs. This makes it difficult to establish the remote assistance management system as a business. On the other hand, if the number of operators is simply reduced, not only the load per operator becomes high, but also when assistance requests of more than the number of operators arrive from autonomous traveling vehicles, it becomes impossible to cope with the requests.

The above-described prior art is based on an assumption that the number of operators is sufficient for assistance requests. If a large number of assistance requests occur at the same time, the above-described prior art may not assign an operator some of the assistance requests. In this case, an autonomous traveling vehicle that does not receive a determination or traveling instruction from the operator may be stalled on a road, and a trouble may occur by an autonomous traveling vehicle traveling with uncertain information.

As a reference showing the technical level of the technical field related to the present disclosure, JP2020-042764A can be exemplified in addition to JP2019-185279A.

### SUMMARY

The present disclosure has been made in view of the above-mentioned problems, and an object thereof is to provide a technique capable of reducing the number of operators required for remote assistance of autonomous traveling vehicles while maintaining smooth traffic by the remote assistance.

The present disclosure provides a remote assistance management system for achieving the above object. The remote assistance management system according to the present disclosure is a system in communication with a plurality of autonomous traveling vehicles for letting an operator provide remote assistance in response to an assistance request from an autonomous traveling vehicle. The remote assistance management system includes at least one memory including at least one program, and at least one processor coupled with the at least one memory. The at least one program causes the at least one processor to predict, for each autonomous traveling vehicle, the occurrence of an assistance request in future based on an operation state of each autonomous traveling vehicle, and to calculate a predicted assistance period for each the assistance request predicted to occur. when more than a predetermined number of overlapping assistance requests of which predicted assistance periods overlap at the same time are predicted to occur, the at least one program causes the at least one processor to instruct a change of a traveling mode to excess vehicles that are autonomous traveling vehicles in excess of the predetermined number among autonomous traveling vehicles from which the overlapping assistance requests are predicted to occur. In particular, the at least one program causes the at least one processor to instruct to the excess vehicles a change of the traveling mode from a first traveling mode being a normal traveling mode to a second traveling mode for avoiding or delaying an assistance request to occur.

According to the remote assistance management system, the occurrence of an assistance request in future is predicted in advance for each autonomous traveling vehicle. Then, when predicted assistance periods of a plurality of assistance requests overlap at the same time, and the number of overlaps exceeds the predetermined number, the change of the traveling mode is instructed to the autonomous traveling vehicles in excess of the predetermined number among the autonomous traveling vehicles from which the overlapping assistance requests are predicted to occur. By changing the traveling mode, the occurrence of an assistance request is avoided, or the occurrence of an assistance request is delayed. As a result, when a plurality of assistance requests actually occur, the number of assistance requests of which the assistance periods overlap at the same time is suppressed to the predetermined number or less. As a result, the load of the operators performing remote assistance is reduced. This makes it possible to reduce the number of operators required for remote assistance of autonomous traveling vehicles while maintaining smooth traffic by the remote assistance.

In the remote assistance management system, the at least one program may cause the at least one processor to calculate an evaluation value for each of the autonomous traveling vehicles from which the overlapping assistance requests are predicted to occur, and to select an autonomous traveling vehicle to which a change of the traveling mode from the first traveling mode to the second traveling mode is instructed in descending order of the evaluation value. The evaluation value is a value for determining an autonomous traveling vehicle that preferentially avoids or delays the occurrence of an assistance request. The autonomous traveling vehicles whose traveling modes are to be changed may be selected at random. However, by selecting the autonomous traveling vehicle to change the traveling mode in this way based on a certain index, it is possible to more reliably reduce the number of operators required for remote assistance.

As a method of calculating the evaluation value, for example, the following methods are exemplified.

In a first example, for each the assistance request predicted to occur, a probability of the occurrence of the assistance request is calculated and the evaluation value is calculated to be a higher value for an autonomous traveling vehicle from which an assistance request with a higher occurrence probability is predicted to occur. According to the first example, it is possible to avoid the occurrence of an assistance request having a high occurrence probability or to delay the occurrence of such an assistance request, and thereby reducing the load on the operators.

In a second example, for each the assistance request predicted to occur, an influence degree of representing a level of an influence of a cause of the assistance request on surroundings is calculated and the evaluation value is calculated to a higher value for an autonomous traveling vehicle from which an assistance request with a higher influence level is predicted to occur. According to the second example, it is possible to avoid the occurrence of an event having a large influence on the surroundings or to delay the occurrence of such an event, and thereby maintaining smooth traffic.

In a third example, for each the assistance request predicted to occur, a skill of the operator required for handling the assistance request is calculated and the evaluation value is calculated to a higher value for an autonomous traveling vehicle from which an assistance request with a higher skill is predicted to occur. The utilization costs of the operator may depend on the skill level of the operator. According to the third example, it is possible to avoid the occurrence of an assistance request requiring a high skill in handling or to delay the occurrence of such an assistance request, and thereby reducing the utilization costs of the operator.

In a fourth example, for each the assistance request predicted to occur, a handling time required for handling the assistance request is calculated and the evaluation value is calculated to a higher value for an autonomous traveling vehicle from which an assistance request with a longer handling time is predicted to occur. The utilization costs of the operator may depend on the time required to handle the assistance request. According to the fourth example, it is possible to avoid the occurrence of an assistance request that requires a long handling time or to delay the occurrence of such an assistance request, thereby reducing the utilization costs of the operator. In addition, according to the fourth example, it is possible to suppress the operator from being occupied only for the assistance of one autonomous traveling vehicle.

In a fifth example, for each the assistance request predicted to occur, a margin time until the assistance request occurs is calculated and the evaluation value is calculated to a higher value for an autonomous traveling vehicle from which an assistance request with a longer margin time is predicted to occur. According to the fifth example, by avoiding the occurrence of an assistance request having a long margin time or delaying the occurrence of such an assistance request, it is possible to provide a margin in the response time until the autonomous traveling vehicle instructed to change the traveling mode changes the traveling mode. As a result, it is possible to improve the certainty of the change of the traveling mode.

In the remote assistance management system, the at least one program may cause the at least one processor to predict the occurrence of an assistance request at a predetermined update period and to perform prediction to a future time by a predetermined predicted time longer than the predetermined update period. The prediction accuracy can be improved by making the prediction time for predicting the occurrence of an assistance request longer than the update period of the prediction result.

In the remote assistance management system, the at least one program may cause the at least one processor to arrange the operator for an autonomous traveling vehicle that is not instructed to change the traveling mode from the first traveling mode to the second traveling mode among the autonomous traveling vehicles from which the overlapping assistance requests are predicted to occur, and to update arrangement of the operator every update period. By updating the arrangement of the operator in accordance with the update period in which the occurrence of an assistance request is predicted, the operator can be arranged so as to promptly respond to the actual assistance request.

In the remote assistance management system, the at least one memory and the at least one processor may be provided on a server in communication with the plurality of autonomous traveling vehicles. In this case, the server may acquire an operation state of a target autonomous traveling vehicle and operation states of other autonomous traveling vehicles other than the target autonomous traveling vehicle, and predict the occurrence of an assistance request in future from the target autonomous traveling vehicle based on the operation state of the target autonomous traveling vehicle and the operation states of other autonomous traveling vehicles. By predicting the occurrence of an assistance request from the target autonomous traveling vehicle based on not only the operation state of the target autonomous traveling vehicle but also the operation states of other autonomous traveling vehicles in the server, the prediction accuracy of the occurrence of an assistance request can be increased. Incidentally, the operation states of the target autonomous traveling vehicle and other autonomous traveling vehicles may be acquired from each autonomous traveling vehicle, or may be acquired from an operation management server for managing and instructing the operation of the autonomous traveling vehicle (or, a program in the server).

In the remote assistance management system, the at least one memory and the at least one processor may be distributed to an on-board computer mounted on each of the plurality of autonomous traveling vehicles and a server in communication with the on-board computer. In this case, the on-board computer may acquire an operation state of a target autonomous traveling vehicle on which the on-board computer is mounted using a sensor of the target autonomous traveling vehicle, and may predict the occurrence of an assistance request in future from the target autonomous traveling vehicle based on the operation state of the target autonomous traveling vehicle. When an assistance request is predicted to occur, information relating to prediction of the occurrence of the assistance request may be transmitted to the server. By acquiring the operation state of the target autonomous traveling vehicle using the sensor of the target autonomous traveling vehicle on which the on-board computer is mounted, the occurrence of an assistance request from the target autonomous traveling vehicle can be predicted with high responsiveness.

Further, the present disclosure provides a remote assistance management method for achieving the above object. A remote assistance management method according to the present disclosure is a remote assistance management method for a plurality of autonomous traveling vehicles capable of receiving remote assistance from an operator. The remote assistance management method includes a step of predicting, for each autonomous traveling vehicle, the occurrence of an assistance request from an autonomous traveling vehicle to the operator in future based on an operation state of each autonomous traveling vehicle, and a step of calculating a predicted assistance period for each the assistance request predicted to occur. Further, the remote assistance management method includes a step executed when more than a predetermined number of overlapping assistance requests of which predicted assistance periods overlap at the same time are predicted to occur. In this step, excess vehicles are instructed to a change of a traveling mode from a first traveling mode being a normal traveling mode to a second traveling mode for avoiding or delaying the occurrence of an assistance request, the excess vehicles being autonomous traveling vehicles in excess of the predetermined number among autonomous traveling vehicles from which the overlapping assistance requests are predicted to occur.

Further, the present disclosure provides a remote assistance management program for achieving the above object. The remote assistance management program according to the present disclosure is a program causing a computer to communicate with a plurality of autonomous traveling vehicles and let an operator provide remote assistance in response to an assistance request from an autonomous traveling vehicle. The remote assistance management program causes the computer to predict, for each autonomous traveling vehicle, the occurrence of an assistance request in future based on an operation state of each autonomous traveling vehicle, and to calculate a predicted assistance period for each the assistance request predicted to occur. Further, when more than a predetermined number of overlapping assistance requests of which predicted assistance periods overlap at the same time are predicted to occur, the remote assistance management program causes the computer to instruct a change of a traveling mode to excess vehicles in excess of the predetermined number among autonomous traveling vehicles from which the overlapping assistance requests are predicted to occur. More specifically, the remote assistance management program causes the computer to instruct to the excess vehicles a change from a first traveling mode being a normal traveling mode to a second traveling mode for avoiding or delaying an assistance request to occur. The remote assistance management program may be recorded on a non-transitory computer-readable storage medium.

According to the remote assistance management method and the remote assistance management program described above, the occurrence of an assistance request in future is predicted in advance for each autonomous traveling vehicle. Then, when predicted assistance periods of a plurality of assistance requests overlap at the same time, and the number of overlaps exceeds the predetermined number, the change of the traveling mode is instructed to the autonomous traveling vehicles in excess of the predetermined number among the autonomous traveling vehicles from which the overlapping assistance requests are predicted to occur. By changing the traveling mode, the occurrence of an assistance request is avoided or the occurrence of an assistance request is delayed. As a result, when a plurality of assistance requests actually occur, the number of assistance requests of which the assistance periods overlap at the same time is suppressed to the predetermined number or less. As a result, the load of the operators performing remote assistance is reduced. This makes it possible to reduce the number of operators required for remote assistance of autonomous traveling vehicles while maintaining smooth traffic by the remote assistance.

As described above, according to the remote assistance management system, the remote assistance management method, and the remote assistance management program according to the present disclosure, it is possible to reduce the number of operators required for remote assistance of autonomous traveling vehicles while maintaining smooth traffic by the remote assistance.

### BRIEF DESCRIPTION OF THE DRAWINGS

FIG. 1 is a configuration diagram of a remote monitoring system for autonomous traveling vehicles.

FIG. 2 is a block diagram showing an example of a configuration of an autonomous traveling vehicle.

FIG. 3 is a block diagram showing an example of a configuration of a monitoring center.

FIG. 4 is a diagram showing an example of load of operators when assistance requests occur from a plurality of autonomous traveling vehicles.

FIG. 5 is a diagram showing an example of ranking of potential assistance requests by evaluation values.

FIG. 6 is a diagram showing an example of optimization of load of operators by avoiding the occurrence of an assistance request.

FIG. 7 is a diagram showing an example of optimization of load of operators by delaying the occurrence of an assistance request.

FIG. 8 is a diagram showing a first specific example of a change of a traveling mode.

FIG. 9 is a diagram showing a second specific example of the change of the traveling mode.

FIG. 10 is a diagram showing a third specific example of the change of the traveling mode.

FIG. 11 is a configuration diagram of a remote assistance management system according to a first embodiment of the present disclosure.

FIG. 12 is a sequence diagram showing a flow of information between an assistance requiring vehicle (vehicle A), an assistance non-requiring vehicle (vehicle B), a remote assistance management planner, and an operator by the remote assistance management system according to the first embodiment of the present disclosure.

FIG. 13 is a system configuration diagram of a remote assistance management system according to a second embodiment of the present disclosure.

FIG. 14 is a sequence diagram showing a flow of information between an assistance requiring vehicle (vehicle A), an assistance non-requiring vehicle (vehicle B), a remote assistance management planner, and an operator by the remote assistance management system according to the second embodiment of the present disclosure.

### DETAILED DESCRIPTION

Hereunder, embodiments of the present disclosure will be described with reference to the drawings. Note that when the numerals of numbers, quantities, amounts, ranges and the like of respective elements are mentioned in the embodiments shown as follows, the present disclosure is not limited to the mentioned numerals unless specially explicitly described otherwise, or unless the disclosure is explicitly designated by the numerals theoretically. Furthermore, structures that are described in the embodiments shown as follows are not always indispensable to the disclosure unless specially explicitly shown otherwise, or unless the disclosure is explicitly designated by the structures or the steps theoretically.

### 1. Basic Configuration of Remote Assistance Management System

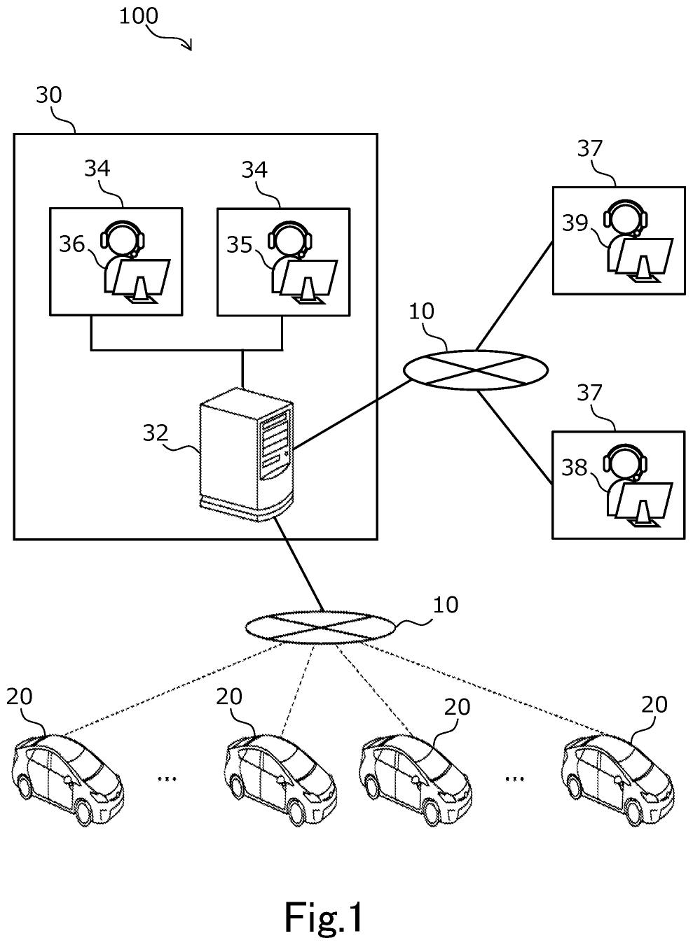

FIG. 1 is a configuration diagram of a remote monitoring system for autonomous traveling vehicles. The remote monitoring system 100 is a system for remotely monitoring autonomous traveling vehicles 20 by remote operators 35, 36, 38, 39. Hereinafter, a remote operator is simply referred to as an operator. The autonomous traveling level of autonomous traveling vehicles 20 to be subject to remote monitoring is assumed to be level 4 or level 5, for example. Hereinafter, an autonomous traveling vehicle is simply referred to as a vehicle. A vehicle representing the plurality of vehicles is referred to as a “vehicle 20”, and the entirety of the plurality of vehicles is referred to as “vehicles 20”.

The operators 35, 36, 38, 39 include, for example, in-house operators 35, 36 that monitor vehicles 20 in a monitoring center 30, and outside operators 38, 39 that monitor vehicles 20 at home. A server 32 is installed in the monitoring center 30. Operation terminals 34 operated by the in-house operators 35, 36 are connected to the server 32 through a LAN in the monitoring center 30. Operation terminals 37 operated by the outside operators 38, 39 are connected to the server 32 via a communication network 10 including the Internet. The number of the operation terminals 34, 37 is prepared in accordance with the number of the operators 35, 36, 38, 39.

One function of the remote monitoring system 100 is remote assistance management of vehicles 20. A system for performing remote assistance management is a remote assistance management system according to each embodiment of the present disclosure. In a first embodiment, the server 32 in the monitoring center 30 functions as the remote assistance management system, and in a second embodiment, the server 32 in the monitoring center 30 and on-board computers of the vehicles 20 constitute the remote assistance management system. The server 32 is connected to vehicles 20 via the communication network 10 including 4G and 5G.

The remote assistance management system is a system that communicates with vehicles traveling autonomously and lets an operator provide remote assistance in response to an assistance request from a vehicle. In the remote assistance, at least a part of determination for autonomous traveling by the vehicle is performed by the operator. Basic calculations of perception, determination, and operation required for traveling are performed in the vehicle. The operator, based on information transmitted from the vehicle, determines an action to be taken by the vehicle, and instructs it to the vehicle. The remote assistance commands sent from the operator to the vehicle include a command to advance the vehicle and a command to stop the vehicle. The remote assistance command may include an offset avoidance command for avoiding an obstacle in front, an overtaking command for overtaking a preceding vehicle, an emergency evacuation command, and the like.

The skills of the operators 35, 36, 38, 39 for remote assistance are not uniform. The In-house operators 35, 36 are divided into operators 35 with high skills and operators 36 with low skills. Similarly, the outside operators 38, 39 are divided into operators 38 with high skills and operators 39 with low skills. In general, the utilization costs (personnel costs) of operators 35, 38 with high skills are relatively high, and the utilization costs of operators 36, 39 with low skills are relatively low. The number of the operators 35,36,38,39 is one or more, preferably two or more. In particular, it is preferred that at least one in-house operator 35 with high skills exists.

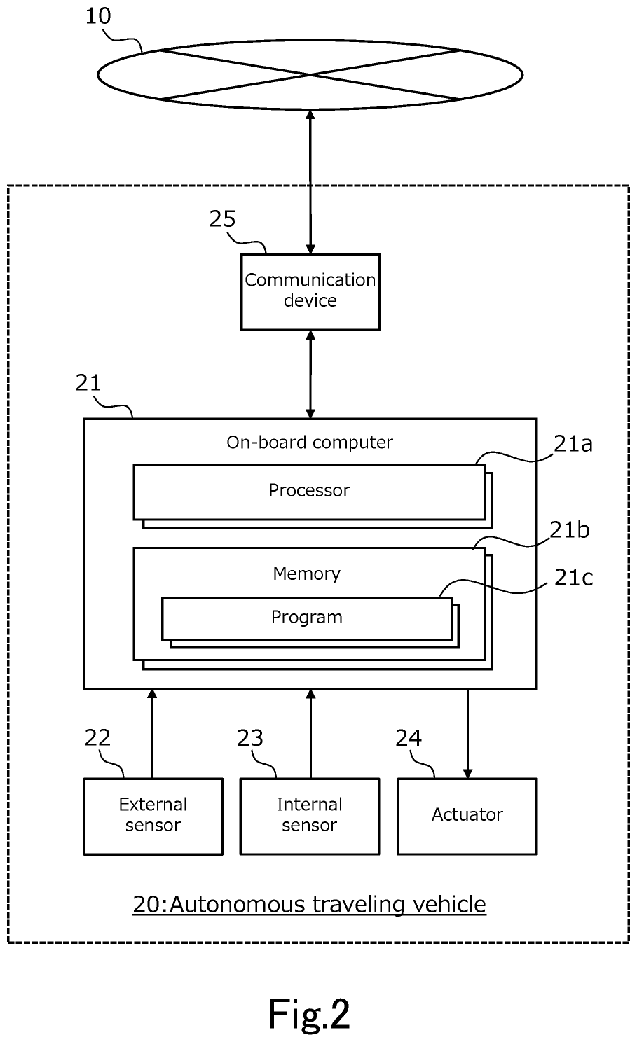

FIG. 2 is a block diagram showing an example of a configuration of the vehicle 20. The vehicle 20 includes an on-board computer 21. The on-board computer 21 is an assembly of a plurality of ECUs (Electronic Control Unit) mounted on the vehicle 20. The vehicle 20 also includes an external sensor 22, an internal sensor 23, an actuator 24, and a communication device 25. These are connected to the on-board computer 21 using in-vehicle networks such as Controller Area Network.

The on-board computer 21 includes one or more processors 21a (hereinafter, simply referred to as a processor 21a) and one or more memories 21b (hereinafter, simply referred to as a memory 21b) coupled to the processor 21a. The memory 21b stores one or more programs 21c (hereinafter, simply referred to as a program 21c) executable by the processor 21a and various related information.

When the processor 21a executes the program 21c, various kinds of processing performed by the processor 21a are realized. The program 21c includes, for example, a program for realizing autonomous traveling and a program for realizing remote assistance. In the case of the second embodiment, the program 21c includes a program for causing the on-board computer 21 to function as a part of the remote assistance management system. The memory 21b includes a non-transitory computer-readable storage medium that includes a main storage device and an auxiliary storage device. The program 21c may be stored in the main storage device or may be stored in the auxiliary storage device. The auxiliary storage device may store a map database for managing map information for autonomous traveling.

The external sensor 22 includes a camera for photographing surroundings of the vehicle 20, particularly in front of the vehicle 20. A plurality of cameras may be provided, and may photograph side and rear of the vehicle 20 too. Further, the camera may be shared between autonomous traveling and remote assistance by an operator, or the camera for autonomous traveling and the camera for remote assistance may be provided separately.

The external sensor 22 includes a perception sensor in addition to the camera. The perception sensor is a sensor that acquires information for perceiving surrounding conditions of the vehicle 20. Examples of the perception sensor other than the camera include a LiDAR (Laser Imaging Detection and Ranging) and a millimeter-wave radar. The external sensor 22 also includes a location sensor for detecting the location and orientation of the vehicle 20. As the location sensor, a Global Positioning System (GPS) sensor is exemplified. Information acquired by the external sensor 22 is transmitted to the on-board computer 21. The external sensor 22 also includes a microphone that collects sound around the vehicle 20.

The inner sensor 23 includes a state sensor that acquires information about the motion of the vehicle 20. As the state sensor, for example, a wheel speed sensor, an acceleration sensor, an angular velocity sensor, and a steering angle sensor are exemplified. The acceleration sensor and the angular velocity sensor may constitute an IMU. Information acquired by the internal sensor 23 is transmitted to the on-board computer 21. Hereinafter, the information acquired by the internal sensor 23 and the information acquired by the external sensor 22 are collectively referred to as operation state information of the vehicle 20. However, the operation state information includes not only the information acquired by sensors of the vehicle 20 but also information acquired by an operation management server that manages the operation of the vehicle 20.

The actuator 24 includes a steering system for steering the vehicle 20, a driving system for driving the vehicle 20, and a braking system for braking the vehicle 20. The steering system includes, for example, a power steering system, a steer-by-wire steering system, and a rear wheel steering system. The driving system includes, for example, an engine system, an EV system, and a hybrid system. The braking system includes, for example, a hydraulic braking system and a power regenerative braking system. The actuator 24 operates by a control signal transmitted from the on-board computer 21.

The communication device 25 is a device for controlling wireless communication with the outside of the vehicle 20. The communication device 25 communicates with the server 32 via the communication network 10. Information processed by the on-board computer 21 is transmitted to the server 32 using the communication device 25. Information processed by the server 32 is captured by the on-board computer 21 using the communication device 25. Also, if vehicle-to-vehicle communication with other vehicles or road-to-vehicle communication with infrastructure facilities is required for autonomous traveling, communication with those external devices is also performed by the communication device 25.

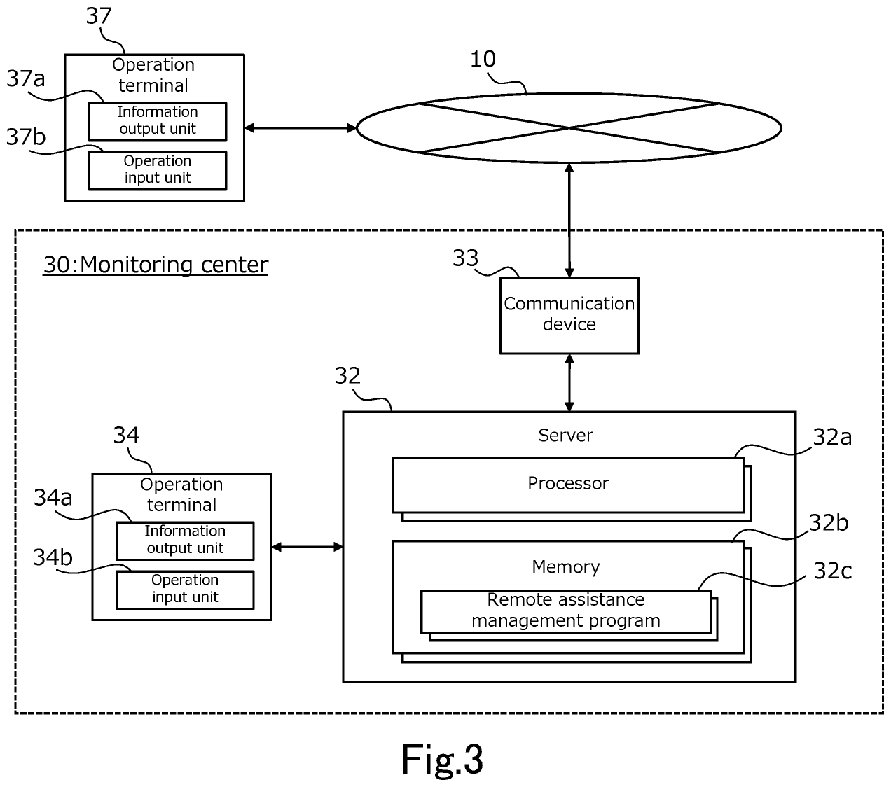

FIG. 3 is a block diagram showing an example of a configuration of the monitoring center 30. In the monitoring center 30, a communication device 33 and one or more operation terminals 34 (an operation terminal representing the one or more operation terminals 34 is referred to as an “operation terminal 34”) are installed in addition to the server 32. The communication device 33 is a device for controlling communication with the outside of the monitoring center 30. The communication device 33 mediates communication between the server 32 and the vehicles 20 via the communication network 10. The information processed by the server 32 is transmitted to the vehicle 20 using the communication device 33. The information processed by the vehicle 20 is captured by the server 32 using the communication device 33. The communication device 33 mediates communication between the server 32 and one or more operation terminals 37 (an operation terminal representing the one or more operation terminals 37 is referred to as an “operation terminal 37”) installed outside the monitoring center 30.

The server 32 may be a computer or a set of computers connected by a communication network. The server 32 includes one or more processors 32a (hereinafter simply referred to as a processor 32a) and one or more memories 32b (hereinafter simply referred to as a memory 32b) coupled to the processor 32a. The memory 32b stores one or more programs 32c (hereinafter, simply referred to as a program 32c) executable by the processor 32a and various related information.

When the processor 32a executes the program 32c, various kinds of processing performed by the processor 32a are realized. In the first embodiment, the program 32c includes a program (remote assistance management program) that causes the server 32 to function as the remote assistance management system. In the second embodiment, the program 32c includes a program that causes the server 32 to function as a part of the remote assistance management system. The memory 32b includes a non-transitory computer-readable storage medium that includes a main storage device and an auxiliary storage device. The program 32c may be stored in the main storage device or may be stored in the auxiliary storage device. The auxiliary storage device may store a map database for managing map information for autonomous traveling. The map database may be stored in at least one of the server 32 and the on-board computer 21.

The operation terminals 34, 37 comprises information output units 34a, 37a respectively. The information output units 34a, 37a are devices for outputting information necessary for remote assistance of the vehicle 20 to the operators 35, 36, 38, 39. Information output from the information output units 34a, 37a is transmitted from the server 32 to the respective operation terminals 34, 37. The information output unit 34a, 37a includes a display for outputting images and a speaker for outputting sounds. On the display, for example, an image in front of the vehicle 20 photographed by the camera of the vehicle 20 is displayed. The display may have a plurality of display screens and may display images of the side and/or the rear of the vehicle 20. The speaker, for example, communicates sounds of surroundings of the vehicle 20 collected by the microphone to the operator.

The operation terminals 34, 37 include operation input units 34b, 37b respectively. The operation input units 34b, 37b are devices for inputting operations for remote assistance from the operators 35, 36, 38, 39. Information input by the operation input units 34b, 37b is transmitted from the server 32 to the vehicles 20 corresponding to the operation input units 34b, 37b, respectively. Examples of the input device include a button, a lever, and a touch panel. For example, advance/stop or a lateral movement may be instructed to the vehicle 20 by the direction in which the lever is tilted. The lateral movement includes, for example, offset avoidance against an obstacle ahead, lane changing, and overtaking of a preceding vehicle.

### 2. Summary of Remote Assistance Management System

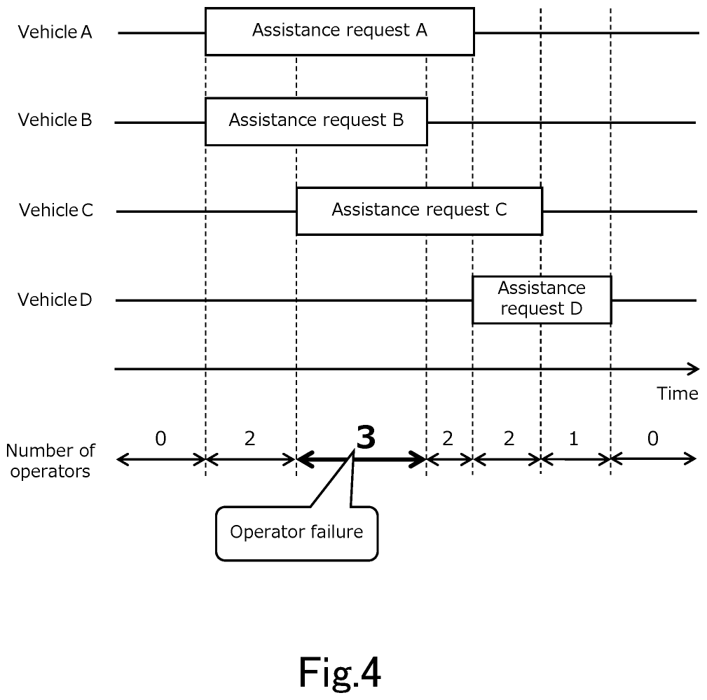

It is an object of the remote assistance management system of the present disclosure to reduce the number of operators required for remote assistance of vehicles while maintaining smooth traffic by the remote assistance. Hereinafter, the load of the operators will be described in the case where a plurality of vehicles are operated with reference to FIG. 4. FIG. 4 shows an example of the load of the operators when assistance requests occur from four vehicles A, B, C, D in a situation where these four vehicles A, B, C, D are in operation. The load of the operators here means the number of operators required to handle assistance requests.

In the example shown in FIG. 4, assistance requests are generated from the respective vehicles A, B, C, D at discrete times. The horizontal axis of the chart represents time, and the length of each rectangle corresponding to each assistance request represents the time required for handling each assistance request, that is, the assistance time. The assistance time required depends on the content of each assistance request. In the example shown in FIG. 4, assistance times overlap at the same time between a plurality of assistance requests. For example, the assistance request A overlaps with the assistance request B, and at the same time overlaps with the assistance request C. In this way, when assistance requests overlap at the same time, as many operators as the number of overlapping assistance requests are required. In the example shown in FIG. 4, the maximum number of operators is three. However, if there are only two operators, any one of the assistance requests A, B, C cannot be handled, resulting in a failure. A situation in which an operator cannot be assigned to an assistance request is called an operator failure.

The remote assistance management system of the present disclosure executes processing for preventing the above-described failure. In general, the remote assistance management system of the present disclosure predicts, for each vehicle, the occurrence of an assistance request in future based on an operation state of each vehicle, and calculates a predicted assistance period for each the assistance request predicted to occur. The predicted assistance period is a period that is predicted to be necessary for handling the assistance request. Since a standard assistance time is statistically determined for each assistance request according to the content of each assistance request, the predicted assistance period is calculated using the standard assistance time. Hereinafter, an assistance request that is expected to occur in future may be referred to as a potential assistance request. Information on the operation state used for prediction of the potential assistance requirement includes, for example, map information, vehicle location information, travel route information, and vehicle speed information.

As a situation in which the occurrence of an assistance request is predicted, for example, the following situation can be exemplified. A first example is a signal intersection without road-to-vehicle communication equipment (V2I). At the signal intersection without road-to-vehicle communication equipment, the occurrence of an assistance request is predicted for determining surrounding situations and lighting colors of a signal. By registering information on the presence or absence of road-to-vehicle communication equipment in advance in a database, it is possible to calculate the predicted occurrence time and the predicted assistance time of the potential assistance request from the vehicle location information, the travel route information, and the vehicle speed information.

A second example is dense areas of large freight vehicles and large passenger vehicles. When a large vehicle with a large length is adjacent to the ego-vehicle, the occurrence of an assistance request is predicted because it leads to lowering of perception accuracy of objects by a perception sensor. Parking record data of large vehicles are collected by sensors of each vehicle before and during the operation of the remote assistance management system, and a trend analysis is performed from the collected parking record data, so that a location and time zone at which a high frequency of encounter with a dense mass of large vehicles can be specified. By registering the specified location and time zone at which large vehicles are concentrated in the database, the predicted occurrence time and the predicted assistance time of the potential assistance request can be calculated from the vehicle location information, the travel route information, and the vehicle speed information.

A third example is a case where the perception accuracy is lowered due to aging of the LiDAR. The LiDAR performs sensing using the reflection intensity of emitted laser beams. For this reason, a decrease in the absolute value of the reflection intensity of emitted laser beams means a decrease in the perception performance, thereby decreasing the reliability of autonomous traveling. Therefore, when the perception accuracy of the LiDAR is lowered, the occurrence of an assistance request is predicted. A semiconductor laser used in the LiDAR has fast degradation due to optical damage caused by heat or overcurrent or the like, and slow degradation due to crystal formation and fabrication processes. Here, a monitoring result of the reflection intensity from a certain reference object is acquired as the operation state information, focusing on the slow degradation. Unlike the first and second examples, in the third example, the monitoring result as the operation state information is monitored for a long period of time, thereby predicting the occurrence of an assistance request due to aging degradation.

The remote assistance management system of the present disclosure updates the prediction result of the potential assistance request at a predetermined update period. Then, each time the update is performed, the potential assistance request is predicted up to a future time by a predetermined predicted time longer than the update period. As an example, the update period may be one second, and the prediction time of the potential assistance request may be one minute. By making the prediction time for predicting the potential assistance request longer than the update period of the prediction result, the prediction accuracy can be improved.

The remote assistance management system of the present disclosure predicts the potential assistance request for each vehicle and determines whether predicted assistance periods overlap at the same time among a plurality of the potential assistance requests. The predicted assistance period means a period in which an operator is bound to one assistance request. Therefore, if predicted assistance periods overlap among a plurality of potential assistance requests, at least as many operators as the number of overlapping potential assistance requests are required. Hereinafter, potential assistance requests in which predicted assistance periods overlap at the same time are referred to as overlapping assistance requests.

When the number of overlapping assistance requests exceeds a predetermined number and the shortage of operators is predicted, the remote assistance management system of the present disclosure avoids the shortage of operators by instructing some vehicles to change the traveling mode. The change of the traveling mode performed here is a change from a first traveling mode, which is a normal traveling mode, to a second traveling mode for avoiding or delaying the occurrence of an assistance request to avoid the occurrence of the overlapping assistance requests. The normal traveling mode is a traveling mode where autonomous traveling can be performed most efficiently and comfortably for an occupant. The vehicles to which the change of the traveling mode is instructed is vehicles in excess of a predetermined number among vehicles from which the overlapping assistance requests are predicted to occur. Typically, the predetermined number is the number of standby operators available. Specifically, which vehicle is instructed to change the traveling mode is determined based on an evaluation value calculated for each vehicle in which the occurrence of the overlapping assistance requests is predicted.

The evaluation value is used to determine a vehicle where the occurrence of an assistance request is preferentially avoided or delayed. Among the vehicles from which the overlapping assistance requests are predicted to occur, the traveling mode is changed preferentially from a vehicle with a high evaluation value. The evaluation value is calculated using five variables: occurrence probability, influence level, required skill, handling time, and margin time. The following equation (1) is an example of an equation of the evaluation value expressed by using these five variables. Incidentally, the dimensionless coefficient is a predetermined fixed value.

Evaluation value=dimensionless coefficient×occurrence probability×required skill×handling time×margin time/influence level Equation (1)

The first variable, the occurrence probability, is the probability of the occurrence of an assistance request, and is calculated for each potential assistance request. According to the above equation (1), the evaluation value is calculated to a higher value for a vehicle where an assistance request with a higher occurrence probability is predicted. By setting the evaluation value to a higher value as the occurrence probability of an assistance request is higher, the occurrence of an assistance request with a higher occurrence probability can be avoided or delayed, thereby reducing the load of the operators. As a prediction method of the occurrence probability, the following method can be exemplified. In a first example, the occurrence probability of the assistance request in each time zone is predicted by analyzing occurrence location, occurrence time zone, and occurrence frequency of the assistance request from the past log data. In a second example, the occurrence probability of remote assistance is predicted from traffic conditions (many trucks, etc.), road conditions (intersections, etc.) and weather conditions of passing points.

The second variable, the influence level, is a numerical value representing the level of influence on surroundings by the cause of the potential assistance request. In the following list, events assumed are largely categorized based on the concept of the influence level. The value assigned to each category is the influence level. Here, the influence level is set to six levels, from 1 to 6, and the numerical value 1 targets events with the largest influence level, and the influence level decreases as the numerical value increases. The influence level of events related to abnormalities and failures is high, and the influence level of events in a normal state is low.

<Influence level 1> Prediction of occurrence of traffic accident
<Influence level 2> Prediction of difficulty in continuing travel due to failure or abnormality
<Influence level 3> Prediction of degenerate operation due to failure or abnormality
<Influence level 4> Prediction of event with rear collision risk due to behavior of ego-vehicle
<Influence level 5> Prediction of event with traffic flow disturbing risk
<Influence level 6> Prediction of event affecting operation delay and ride comfort

The influence level is calculated for each potential assistance request. According to the above equation (1), the evaluation value is calculated to a higher value for a vehicle where an assistance request with a higher influence level is predicted. By setting the evaluation value to a higher value as the influence on surroundings by the cause of the potential assistance request is higher, the occurrence of an event having a large influence on surroundings can be avoided or delayed, thereby maintaining smooth traffic can be maintained. The above-mentioned influence level can also be referred to as a priority for determining the order of changing the traveling mode.

The third variable, the required skill, is the skill of the operator required to handle the predicted potential assistance request and is calculated for each potential assistance request. The higher the required skill, the higher the utilization costs of the operator. According to the above equation (1), the evaluation value is calculated to a higher value for a vehicle where an assistance request with a higher required skill is predicted. By setting the evaluation value to a higher value as the required skill is higher, the occurrence of an assistance request requiring a higher skill for handling can be avoided or delayed, thereby reducing the utilization costs of the operator.

The fourth variable, the handling time, is the time required to handle the predicted potential assistance request, and is calculated for each potential assistance request. The longer the handling time, the higher the utilization costs of the operator. According to the above equation (1), the evaluation value is calculated to a higher value for a vehicle for which an assistance request with a longer handling time is predicted. By setting the evaluation value to a higher value as the handling time is longer, the occurrence of an assistance request requiring a longer handling time can be avoided or delayed, thereby reducing the utilization costs of the operator. At the same time, it is possible to suppress the operator from being occupied only for the assistance of one vehicle. Also, the handling time and the required skill can be used to calculate a task level representing a difficulty level of an assistance request. An assistance request with a high task level should preferably be assigned to a high-skilled operator.

The fifth variable, the margin time, is the time from the prediction of the potential assistance request to the actual occurrence of an assistance request, and is calculated for each potential assistance request. If there is not sufficient margin before the assistance request occurs, it is difficult to avoid or delay the occurrence of the assistance request even when the traveling mode is changed. According to the above equation (1), the evaluation value is calculated to a higher value for a vehicle where an assistance request with a longer margin time is predicted. According to this, the occurrence of an assistance request having a long margin time can be avoided or delayed referentially, thereby providing a margin in the response time until the vehicle instructed to change the traveling mode changes the traveling mode. As a result, the reliability of avoidance or delay of the occurrence of an assistance request by the change of the traveling mode can be improved.

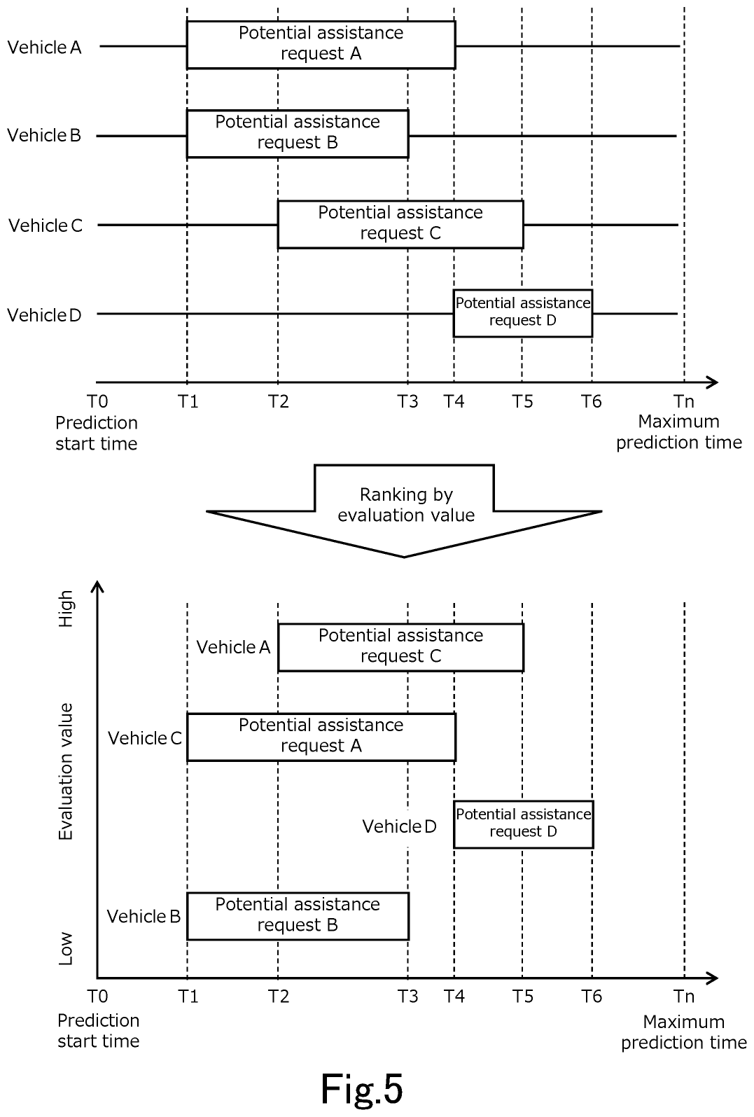

FIG. 5 shows an example in which the potential assistance requests A, B, C, D are predicted for vehicles A, B, C, D respectively, and ranked according to the evaluation values for vehicles A, B, C, D calculated in the above-mentioned method. In the example shown in FIG. 5, the degree of overlap between the potential assistance requests A, B, C is the highest, and the evaluation value of the vehicle C is the highest among the vehicles A, B, C in which the potential assistance requests A, B, C overlap. Therefore, when the occurrence of an assistance request is avoided or delayed, the traveling mode is changed preferentially from the vehicle C having the highest evaluation value.

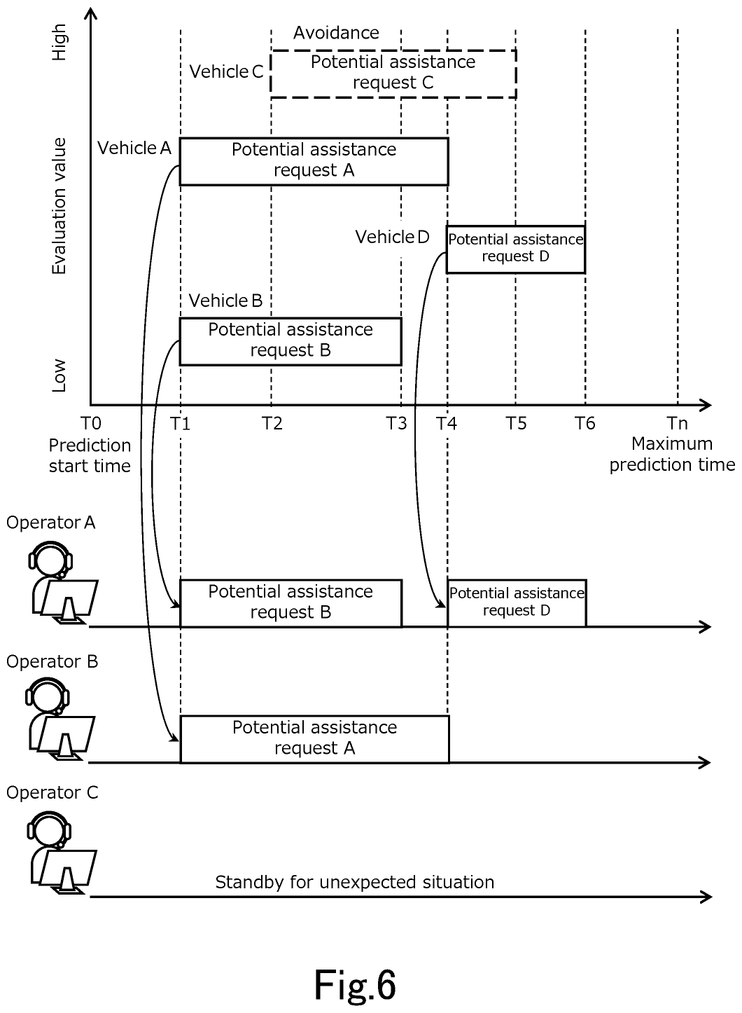

FIG. 6 is a diagram showing an example of optimization of the load of the operators by avoiding the occurrence of an assistance request. Here, the potential assistance request C is avoided by changing the traveling mode of the vehicle C. Of the remaining potential assistance requests A, B, D, the potential assistance requests B, D are assigned to the operator A, and the potential assistance request A is assigned to the operator B. The operator A assigned with the potential assistance requests B, D executes remote assistance for the vehicles B, D in response to assistance requests actually generated from the vehicles B, D. The operator B assigned with the potential assistance request A executes remote assistance for the vehicle A in response to an assistance request actually generated from the vehicle A. Further, since the potential assistance request C is avoided, the occurrence of an assistance request from the vehicle C is avoided.

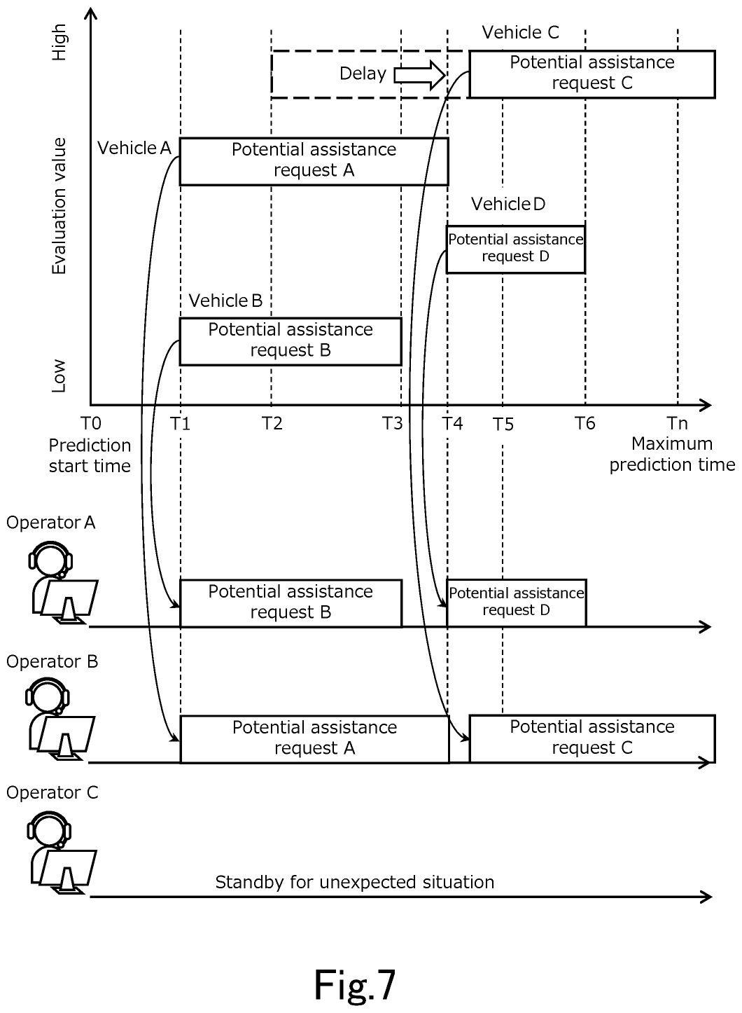

FIG. 7 is a diagram showing an example of optimization of the load of the operators by delaying the occurrence of an assistance request. Here, by changing the traveling mode of the vehicle C, the potential assistance request C is delayed, and the overlap with the potential assistance requests A, B at the same time is eliminated. Of the potential assistance requests A, B, C, D, the potential assistance requests B, D are assigned to the operator A, and the potential assistance request A and the delayed potential assistance request C are assigned to the operator B. The operator A assigned with the potential assistance requests B, D executes remote assistance for the vehicles B, D in response to assistance requests actually generated from the vehicles B, D. The operator B assigned with the potential assistance requests A, C executes remote assistance for the vehicles A, C in response to assistance requests actually generated from the vehicles A, C. Since the potential assistance request C is delayed, an assistance request actually generated from the vehicle C is also delayed.

As in the examples shown in FIGS. 6 and 7, by instructing, among the vehicles A, B, C in which the occurrence of an overlapping assistance requests is predicted, the vehicle C with the highest evaluation value to change the traveling mode, the occurrence of overlapping assistance requests can be avoided, thereby optimizing the load of the operators. Specifically, when the occurrence of overlapping assistance requests is not avoided, three operators are required as in the example shown in FIG. 4, but by avoiding the occurrence of the overlapping assistance requests, two operators are sufficient. The operator C in the example shown in FIGS. 6 and 7 is a standby operator waiting for an unexpected situation different from the prediction. According to the remote assistance management system of the present disclosure, a certain number of such standby operators can be secured by optimizing the load of the operators.

Next, the change of the traveling mode will be described. The change of the traveling mode includes control such as changing a traveling plan, changing a speed profile including vehicle speed and acceleration/deceleration, changing a traveling trajectory, instructing a stop, lighting a lamp, and the like. The remote assistance management system of the present disclosure selects and executes one or more types of control in accordance with the content of the potential assistance request from among the above control.

As a specific example, the following control is selected for each event for which the above-mentioned influence level is set. However, even if the type of control is the same, the value of a parameter like a speed indication value is changed in response to the influence level. For example, the changing content of the speed profile is different between the case where the occurrence of a traffic accident is predicted and the case where an event affecting operation delay and ride comfort is predicted.

<Event 1> Case where Traffic Accident is Expected to Occur

(Control 1) Change of traveling plan

(Control 2) Change of speed profile including vehicle speed and acceleration/deceleration

(Control 3) Change of traveling trajectory

(Control 4) Instruction of stop

<Event 2> Case where Difficulty in Continuing Traveling is Predicted Due to Failure or abnormality

(Control 1) Change of traveling plan

(Control 2) Change of speed profile including vehicle speed and acceleration/deceleration

(Control 4) Instruction of stop

(Control 5) lighting of lamp

<Event 3> Case where Degenerate Operation is Predicted Due to Failure or Abnormality

(Control 1) Change of traveling plan

(Control 2) Change of speed profile including vehicle speed and acceleration/deceleration

(Control 3) Change of traveling trajectory

(Control 5) lighting of lamp

<Event 4> Case where Risk of Rear Collision is Predicted Due to Behavior of Ego-Vehicle

(Control 1) Change of traveling plan

(Control 2) Change of speed profile including vehicle speed and acceleration/deceleration

(Control 3) Change of traveling trajectory

<Event 5> Case where Risk of Disturbing Traffic Flow is Predicted

(Control 2) Change of speed profile including vehicle speed and acceleration/deceleration

(Control 3) Change of traveling trajectory

<Event 6)> Case where Affecting Operation Delay and Ride Comfort is Predicted

(Control 2) Change of speed profile including vehicle speed and acceleration/deceleration

(Control 3) Change of traveling trajectory

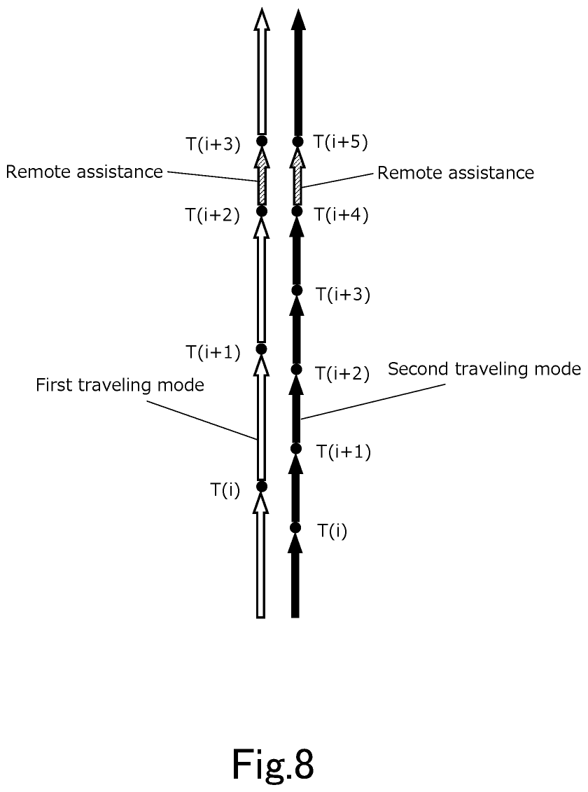

FIGS. 8 to 10 are diagrams showing specific examples of the change of the traveling mode. As a common matter of each diagram, white arrow lines indicate the movement of a vehicle according to the first traveling mode, and black arrow lines indicate the movement of the vehicle according to the second traveling mode. In addition, as a common matter of each diagram, the arrow lines with hatching by diagonal lines indicate the movement of the vehicle by remote assistance.

FIG. 8 shows an example of a change of speed profile including vehicle speed and acceleration/deceleration. For example, if the occurrence of a traffic accident is predicted in front of the traveling direction of the vehicle, the vehicle requires remote assistance to pass the section where handling of the traffic accident is performed. If the section cannot be bypassed, although the assistance request from the vehicle cannot be avoided, the timing at which the assistance request is generated from the vehicle can be delayed by changing the speed profile.

In the example shown in FIG. 8, target locations of the vehicle for each time for each of the first traveling mode and the second traveling mode are indicated by black circles. In this example, in the first traveling mode, the vehicle reaches the remote assistance section at time T(i+2), and in the second traveling mode, the vehicle reaches the remote assistance section at time T(i+4). That is, in the second traveling mode, by lowering the vehicle speed than the first traveling mode, the arrival time to the remote assistance section is delayed. Therefore, in this example, the occurrence of an assistance request can be delayed by changing the traveling mode from the first traveling mode to the second traveling mode.

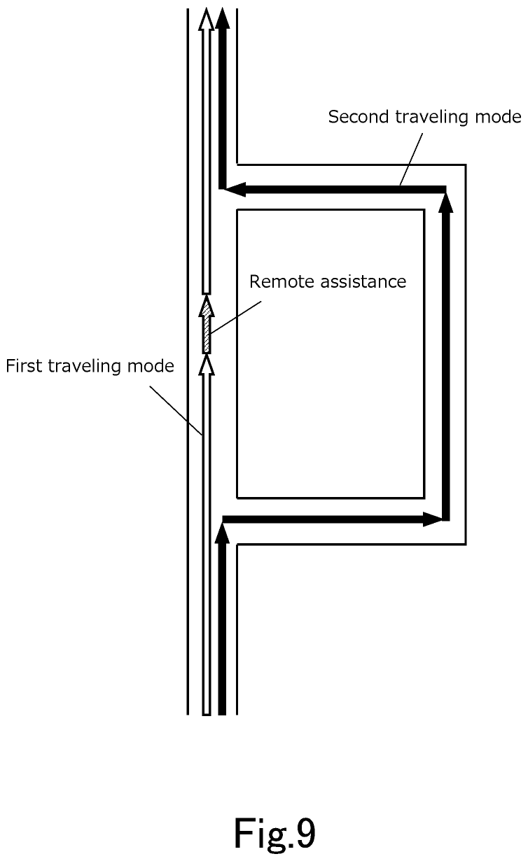

FIG. 9 shows an example of a change of the traveling plan. In the example shown in FIG. 8 described above, although the arrival time to the remote assistance section is delayed by changing the speed profile, if there is a bypass route that bypasses the remote assistance section, the vehicle may change the travel plan so as to travel the bypass route. In the example shown in FIG. 9, a route passing through the remote assistance section is selected in the first traveling mode, whereas a bypass route bypassing the remote assistance section is selected in the second traveling mode. Therefore, in this example, the occurrence of an assistance request can be avoided by changing the traveling mode from the first traveling mode to the second traveling mode.

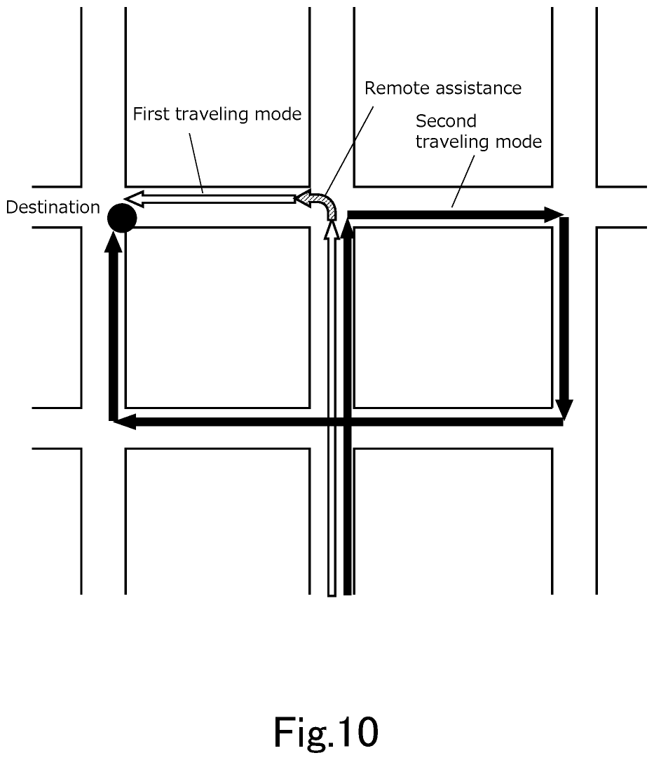

FIG. 10 shows another example of a change of the traveling plan. For example, in the case of a country with right-hand traffic (e.g., the United States, China), it is difficult for a vehicle to make a left turn autonomously at an intersection without a traffic signal or at an intersection without an arrow signal dedicated to a left turn. Therefore, at such an intersection, there is a high probability that an assistance request is generated from the vehicle. In the example shown in FIG. 10, the shortest route for turning left at the intersection and reaching the destination is the route selected in the first traveling mode. However, this route has a high probability of requiring remote assistance. On the other hand, in the second traveling mode, a route to reach the destination while performing right turns repeatedly without performing a left turn is selected. Unlike a left turn, a right turn is unlikely to require remote assistance. Therefore, in this example, the occurrence of an assistance request can be avoided by changing the traveling mode from the first traveling mode to the second traveling mode.

### 3. Configuration of Remote Assistance Management System According to First Embodiment

Next, the configuration of the remote assistance management system according to the first embodiment of the present disclosure will be described. In the first embodiment, when the program (remote assistance management program) 32c stored in the memory 32b of the server 32 is executed by the processor 32a, the server 32 functions as the remote assistance management system. In the first embodiment, the server 32 functioning as the remote assistance management system is called a remote assistance management planner 32.

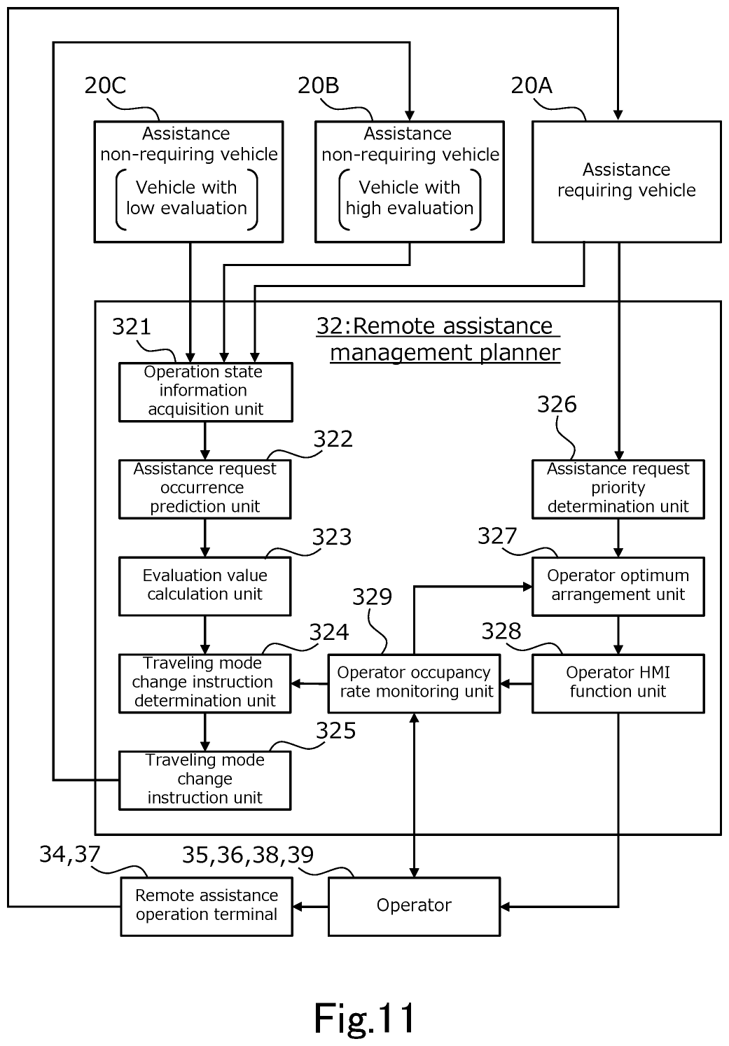

FIG. 11 is a configuration diagram of the remote assistance management system according to the first embodiment, that is, the remote assistance management planner 32. The remote assistance management planner 32 includes an operation state information acquisition unit 321, an assistance request occurrence prediction unit 322, an evaluation value calculation unit 323, a traveling mode change instruction determination unit 324, a traveling mode change instruction unit 325, an assistance request priority determination unit 326, an operator optimum arrangement unit 327, an operator HMI function unit 328, and an operator occupancy rate monitoring unit 329. These are realized as functions of the server 32 as the remote assistance management planner when the program 32c stored in the memory 32b is executed by the processor 32a.

The remote assistance management planner 32 communicates with a plurality of vehicles. Here, the vehicle with which the remote assistance management planner 32 communicates is categorized into an assistance requiring vehicle 20A, an assistance non-requiring vehicle 20B, and an assistance non-requiring vehicle 20C. The assistance requiring vehicle 20A is a vehicle that actually requires remote assistance. The assistance non-requiring vehicle 20B is a vehicle that does not currently need remote assistance, but has a potential assistance request with a high evaluation value. The assistance non-requiring vehicle 20C is a vehicle that does not currently need remote assistance, but has a potential assistance request with a low evaluation value.

The operation state information acquisition unit 321 acquires operation state information of all the vehicles in operation including the vehicles 20A, 20B, 20C. The operation state information includes information acquired from each vehicle and information acquired from the operation management server that manages the operations of vehicles. If the server 32 also functions as the operation management server, the operation state information is passed from a program that causes the server 32 to function as the operation management server to a program that causes the server 32 to function as the remote assistance management planner.

The assistance request occurrence prediction unit 322 predicts the occurrence of an assistance request in future (the potential assistance request) for each vehicle based on the operation state information of each vehicle acquired by the operation state information acquisition unit 321. The assistance request occurrence prediction unit 322 predicts the potential assistance request from a vehicle to be predicted (hereinafter, referred to as the target vehicle) using not only the information acquired from the target vehicle, but also the information acquired from other vehicles other than the target vehicle, the information that the remote assistance management planner 32 has, and the information acquired from the operation management server. Specific examples of situations in which the potential assistance request is predicted to occur are described above.

Furthermore, the assistance request occurrence prediction unit 322 calculates a predicted assistance period for each predicted potential assistance request, that is, a period in which an operator is bound for handling the potential assistance request. Then, the assistance request occurrence prediction unit 322 determines the temporal overlap of the predicted assistance periods between the predicted potential assistance requests, and counts the number of overlapping assistance requests in which the predicted assistance periods overlap at the same time.

The evaluation value calculation unit 323 calculates an evaluation value for determining a vehicle which is caused to preferentially avoid or delay the occurrence of an assistance request for each of the vehicles in which the occurrence of overlapping assistance requests is predicted. As described above, the evaluation value calculation unit 323 acquires five variables, i.e., the occurrence probability, the influence level, the required skill, the handling time, and the margin time for each potential assistance request, and calculates the evaluation value by inputting them to the above equation (1).

The traveling mode change instruction determination unit 324 receives the occupancy state of the operators from the operator occupancy rate monitoring unit 329, which will be described later. Then, the traveling mode change instruction determination unit 324 determines whether all the potential assistance requests predicted by the assistance request occurrence prediction unit 322 can be assigned to the available standby operators. As a result of this initial determination, when an unassignable potential assistance request occurs, or when a predicted occupancy rate of the operators after assignment exceeds an upper limit (e.g., 90%), the traveling mode change instruction determination unit 324 determines that the present situation is in the operator failure. The available standby operators do not include a certain number of standby operators for an unexpected situation who are always prepared (the operator C shown in FIGS. 6 and 7).

When the present situation is in the operator failure, the traveling mode change instruction determination unit 324 selects a vehicle of which the traveling mode is changed, based on the evaluation value acquired from the evaluation value calculation unit 323. More specifically, the traveling mode change instruction determination unit 324 selects the target of avoidance or delay in descending order of the evaluation value for potential assistance requests in excess of the number of available operators, among the plurality of potential assistance requests that cause the overlapping assistance requests causing the operator failure. The traveling mode change instruction determination unit 324 performs final assignment of potential assistance requests to operators on the assumption that the selected potential assistance request is avoided or delayed. Then, the traveling mode change instruction determination unit 324 selects the vehicle which has generated the potential assistance request selected as the target of avoidance or delay, as the target of the change of the traveling mode from the first traveling mode to the second traveling mode.

The traveling mode change instruction unit 325 instructs the change of the traveling mode from the first traveling mode to the second traveling mode to the target vehicle selected by the traveling mode change instruction determination unit 324. The target vehicle is included in the assistance non-requiring vehicle 20B. The traveling mode change instruction unit 325 instructs the target vehicle to perform the control selected according to the content of the potential assistance request, in particular, the content of the influence level as the second traveling mode.

The target vehicle in the assistance non-requiring vehicle 20B changes the traveling mode according to an instruction from the traveling mode change instruction unit 325. When the target vehicle that has received the instruction to change the traveling mode takes action for avoiding or delaying the potential assistance request, assistance requests in excess of the number of available standby operators is avoided from occurring in an overlapping manner. Even if remote assistance becomes necessary after the change of the traveling mode, the operator failure does not happen immediately because standby operators for an unexpected situation are prepared.

Next, processing of an assistance request transmitted from the assistance requiring vehicle 20A to the remote assistance management planner 32 will be described.

The assistance request priority determination unit 326 receives an assistance request from the assistance requiring vehicle 20A. When assistance requests received from a plurality of assistance requiring vehicles 20A overlap temporally, the assistance request priority determination unit 326 prioritizes assistance requests according to the following categories. Numerical values assigned to each category are priority. The priority is set to seven levels, from 1 to 7. Numerical value 1 is set to the event with the highest priority, and the priority decreases as the numerical value increases. The priority is set to high for events related to abnormalities and failures, and the priority is set to low for events in a normal state. However, events related to accident risk are prioritized even under the normal state.

<Priority 1> Case where traffic accident has occurred
<Priority 2> Case where continuing traveling is difficult due to failure or abnormality
<Priority 3> Case where degenerate operation is performed due to failure or abnormality
<Priority 4> Case where risk of collision of ego-vehicle to another vehicle or human exists
<Priority 5> Case where risk of rear collision exists due to behavior of ego-vehicle
<Priority 6> Case where risk of disturbing traffic flow exists
<Priority 7> Case where event affecting operation delay and ride comfort exists

The assistance request priority determination unit 326 determines the category based on the location of the assistance requiring vehicle 20A, the characteristics of roads through which the assistance requiring vehicle 20A passes (intersection, joint flow path, speed limit, etc.), the type of the assistance request flag from the assistance requiring vehicle 20A, and the speed of the assistance requiring vehicle 20A. According to the above category, it can be said that the higher the priority of the assistance request is, the faster the response and the higher the skill are required.

The operator optimum arrangement unit 327 receives the occupancy state of the operators from the operator occupancy rate monitoring unit 329. Then, the available standby operators are arranged according to the priority of each assistance request determined by the assistance request priority determination unit 326. For example, operators 35, 38 having high skills are arranged for assistance requests with relatively high priority, and operators 36, 39 having low skills are arranged for assistance requests with relatively low priority. If in-house operators 35, 36 and outside operators 38, 39 are available, assistance requests may be preferentially distributed to the in-house operators 35, 36, for example.

The operator HMI function unit 328 connects vehicles requiring assistance 20A and operators 35, 36, 38, 39 by HMI in accordance with the combinations of the assistance requests and the standby operators determined by the operator optimum arrangement unit 327. More specifically, the vehicles requiring assistance 20A and the operation terminals 34, 37 operated by the operators 35, 36, 38, 39 are connected to each other. Thus, an image photographed by the camera of the assistance requiring vehicle 20A is displayed on the display screen of the operation terminal 34, or 37 to allow the operator 35, 36, 38, or 39 to confirm the situation of the assistance requiring vehicle 20A. After confirming the situation of the assistance requiring vehicle 20A, the operator 35, 36, 38, or 39 operates the operation terminal 34, or 37 to execute, to the assistance-required vehicle 20A, remote assistance corresponding to the assistance request from the assistance-required vehicle 20A.

The operator occupancy rate monitoring unit 329 calculates the operator occupancy rate based on the connection results of the operators 35, 36, 38, 39 by the operator HMI function unit 328. The operator occupancy rate is, for example, a parameter indicating how many operators will be occupied by remote assistance operation within a predetermined time (e.g., 60 seconds) from the present time. The operator occupancy rate monitoring unit 329 calculates the operator occupancy rate at a predetermined update period, and supplies the updated operator occupancy rate to the traveling mode change instruction determination unit 324 and the operator optimum arrangement unit 327.

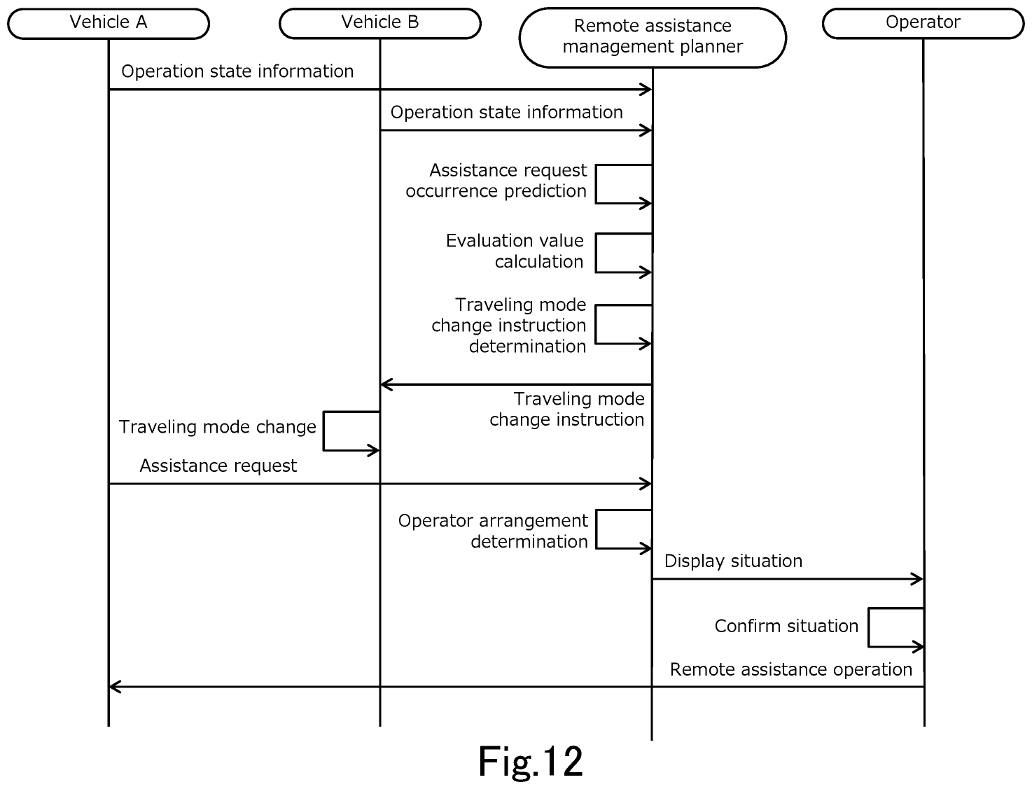

Here, the flow of information realized by the remote assistance management system according to the first embodiment configured as described above will be described with reference to FIG. 12. FIG. 12 is a sequence diagram showing the flow of information between an assistance requiring vehicle (vehicle A), an assistance non-requiring vehicle (vehicle B), the remote assistance management planner, and an operator in the remote assistance management system according to the first embodiment. This sequence diagram also represents the remote assistance management method according to the first embodiment of the present disclosure.

In the example shown in FIG. 12, operation state information is transmitted from each of the vehicle A and the vehicle B to the remote assistance management planner. Though not shown in FIG. 12, operation state information of the vehicle A and the vehicle B is also transmitted from the operation management server to the remote assistance management planner.

The remote assistance management planner predicts the occurrence of an assistance request in future of each of the vehicle A and the vehicle B based on the acquired operation state information of each of the vehicle A and the vehicle B. The remote assistance management planner also calculates a predicted assistance period for each the assistance request predicted to occur, i.e., for each potential assistance request. In the example shown in FIG. 12, it is assumed that potential assistance requests are predicted for both the vehicle A and the vehicle B.

If overlapping assistance requests of which the predicted assistance period overlap at the same time are predicted to occur in excess of the number of available standby operators, the remote assistance management planner calculates the above-mentioned evaluation value for each of the vehicle A and the vehicle B for which the occurrence of the overlapping assistance requests is predicted.

Next, the remote assistance management planner determines whether all predicted potential assistance requests can be assigned to the available standby operators. In the event of an operator failure, the remote assistance management planner selects a vehicle instructing a change of the traveling mode from the first traveling mode to the second traveling mode in descending order of the evaluation value. In the example shown in FIG. 12, the vehicle B is selected as the target vehicle.

Then, the remote assistance management planner instructs the vehicle B selected as the target vehicle to change the traveling mode from the first traveling mode to the second traveling mode. At this time, the remote assistance management planner instructs the vehicle B to perform the control selected according to the content of the potential assistance request, in particular, the content of the influence degree as the second traveling mode.

The vehicle B changes the traveling mode from the first traveling mode to the second traveling mode as instructed by the remote assistance management planner. This avoids or delays an assistance request that would have occurred from the vehicle B in future.

On the other hand, the vehicle A then enters a situation where remote assistance is required as predicted, and transmits an assistance request to the remote assistance management planner.

The remote assistance management planner receives the assistance request from the vehicle A and determines the optimum arrangement of the operators. Then, to the operator selected as the responsibility of the vehicle A, an image showing situations of the vehicle A, which is photographed by the camera of the vehicle A, is displayed on the display.

The operator confirms the situations of the vehicle A from the image displayed on the display, and executes a remote assistance operation for the vehicle A.

As is apparent from the above description, according to the remote assistance management system of the first embodiment, when assistance requests actually occur, the number of assistance requests of which the assistance periods overlap at the same time is suppressed to be equal to or less than the number of available standby operators. As a result, the load of the operators performing remote assistance is reduced, thereby reducing the number of operators required for remote assistance of autonomous traveling vehicles while maintaining smooth traffic by the remote assistance.

### 4. Configuration of Remote Assistance Management System According to Second Embodiment

Next, the configuration of the remote assistance management system according to the second embodiment of the present disclosure will be described. In the second embodiment, when the program 32c stored in the memory 32b of the server 32 is executed by the processor 32a, the server 32 functions as a part of the remote assistance management system. The processor 21a executes the program 21c stored in the memory 21b of the on-board computer 21, whereby the on-board computer 21 functions as a part of the remote assistance management system. The server 32 and the on-board computer 21 mounted on each of the plurality of vehicles are connected via the communication network, thereby configuring the remote assistance management system according to the second embodiment. Here, the plurality of vehicles means all the vehicles under the monitor of the monitoring center 30, including the assistance requiring vehicle 20A, the assistance non-requiring vehicle 20B, and the assistance non-requiring vehicle 20C. In the second embodiment, the server 32 that functions as a part of the remote assistance management system is referred to as the remote assistance management planner 32.

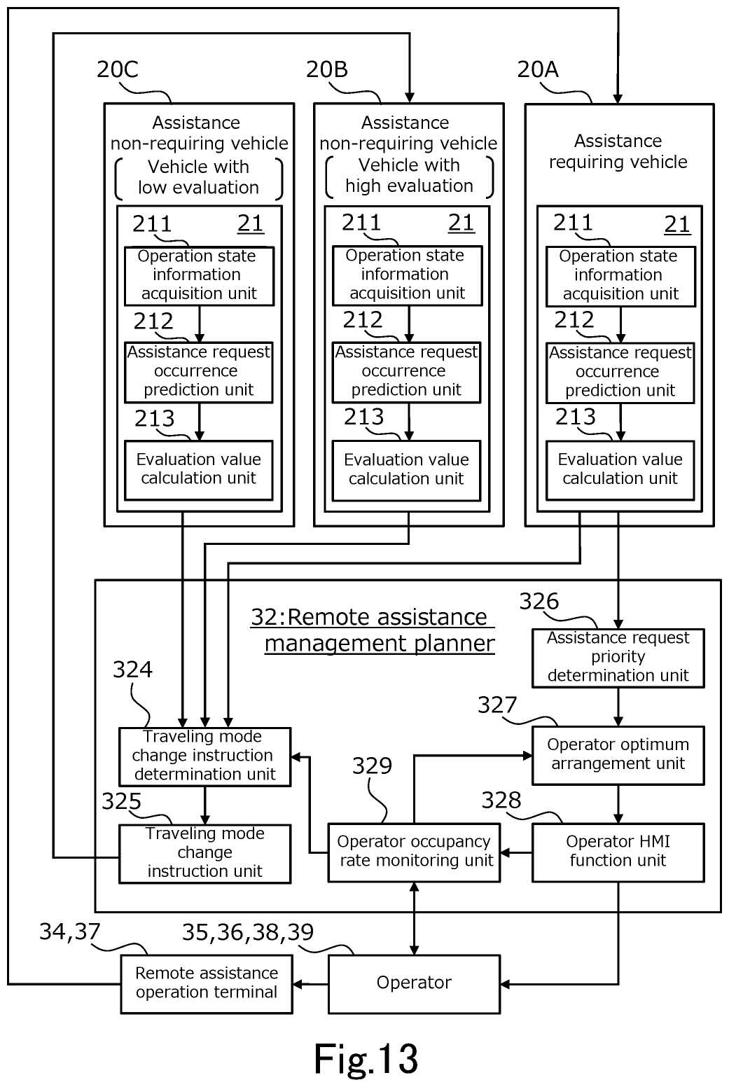

FIG. 13 is a configuration diagram of the remote assistance management system according to the second embodiment. In the second embodiment, a part of the functions of the remote assistance management planner 32 according to the first embodiment is transferred to the on-board computer 21. The on-board computer 21 includes an operation state information acquisition unit 211, an assistance request occurrence prediction unit 212, and an evaluation value calculation unit 213. These are realized as a function of the on-board computer 21 when the program 21c stored in the memory 21b is executed by the processor 21a.

operation state information acquisition unit 211 acquires the operation state information of the target vehicle using the sensor of the target vehicle in which the on-board computer 21 is mounted.

The assistance request occurrence prediction unit 212 predicts the occurrence of an assistance request (potential assistance request) in future based on the operation state information of the target vehicle acquired by the operation state information acquisition unit 211. Then, the predicted assistance period of the predicted potential assistance request is calculated. Whereas the assistance request occurrence prediction unit 322 according to the first embodiment performs prediction using the operation state information of other vehicles, the assistance request occurrence prediction unit 212 according to the second embodiment performs prediction using only the operation state of the target vehicle acquired by the sensor of the target vehicle. Although the first embodiment is more advantageous in terms of the prediction accuracy of the occurrence of an assistance request, according to the first embodiment, the occurrence of an assistance request in the target vehicle can be predicted with high responsiveness.

The evaluation value calculation unit 213 calculates an evaluation value for the potential assistance request predicted by the assistance request occurrence prediction unit 212. The evaluation value calculation unit 213 calculates five variables, i.e., occurrence probability, influence level, required skill, handling time, and margin time of the predicted potential assistance request and calculates the evaluation value by inputting them to the above equation (1).

Each of the vehicles 20A, 20B, 20C transmits the evaluation value and the predicted assistance period of the potential assistance request calculated by the on-board computer 21 to the remote assistance management planner 32.

The remote assistance management planner 32 according to the second embodiment includes a traveling mode change instruction determination unit 324, a traveling mode change instruction unit 325, an assistance request priority determination unit 326, an operator optimum arrangement unit 327, an operator HMI function unit 328, and an operator occupancy rate monitoring unit 329. These are realized as functions of the server 32 as the remote assistance management planner when the program 32c stored in the memory 32b is executed by the processor 32a.

The traveling mode change instruction determination unit 324 receives the occupancy state of operators from the operator occupancy rate monitoring unit 329. Then, it is determined whether or not all of the potential assistance requests acquired from the respective vehicles 20A, 20B, 20C can be assigned to the available standby operators. As a result of this initial determination, when an unassignable potential assistance request occurs, or when a predicted occupancy rate of the operators after assignment exceeds an upper limit, the traveling mode change instruction determination unit 324 determines that the present situation is in the operator failure. In the case of the operator failure, the traveling mode change instruction determination unit 324 selects a vehicle to change the traveling mode based on the evaluation value acquired together with the potential assistance request from the respective vehicle 20A, 20B, 20C.

The traveling mode change instruction unit 325 instructs the change of the traveling mode from the first traveling mode to the second traveling mode to the target vehicle selected by the traveling mode change instruction determination unit 324. The target vehicle is included in the assistance non-requiring vehicle 20B. The traveling mode change instruction unit 325 instructs the target vehicle to perform the control selected according to the content of the potential assistance request, in particular, the content of the influence degree as the second traveling mode. The target vehicle in the assistance non-requiring vehicle 20B changes the traveling mode according to an instruction from the traveling mode change instruction unit 325.

Processing of an assistance request transmitted from the assistance requiring vehicle 20A to the remote assistance management planner 32 is the same as in the first embodiment. Therefore, descriptions of the functions of the assistance request priority determination unit 326, the operator optimum arrangement unit 327, the operator HMI function unit 328, and the operator occupancy rate monitoring unit 329 are omitted.

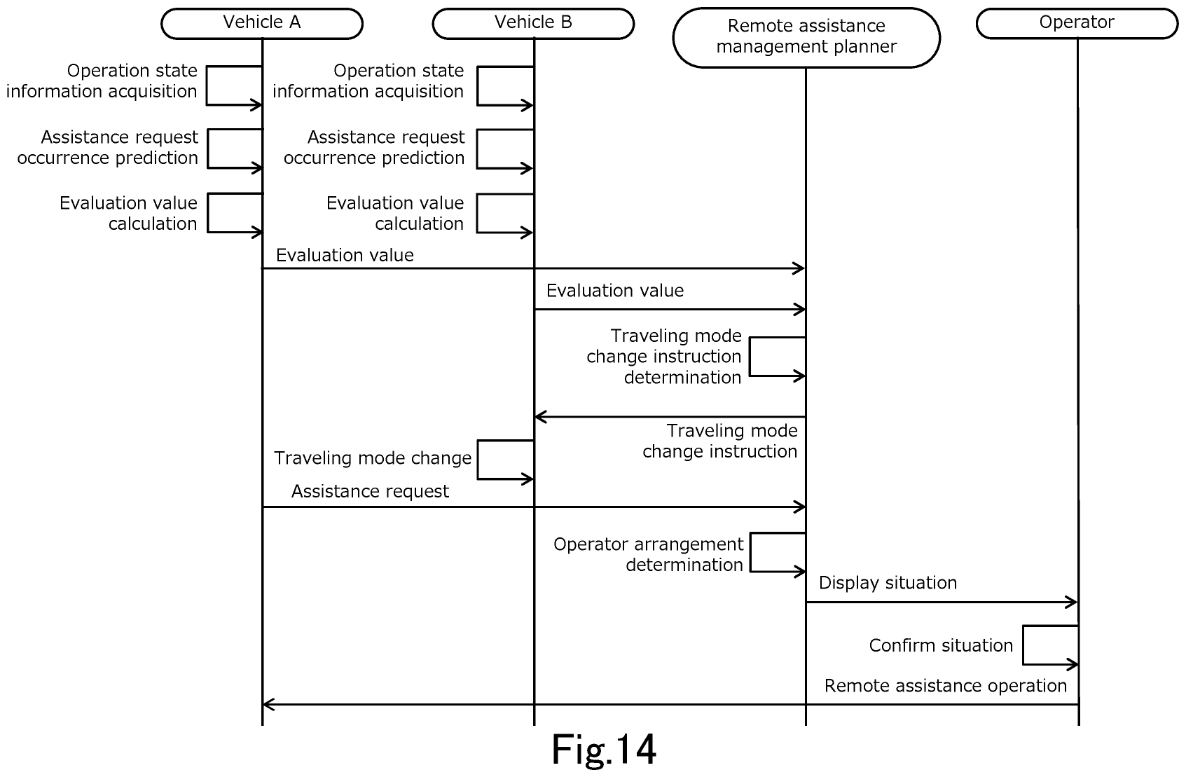

Next, a flow of information realized by the remote assistance management system according to the second embodiment configured as described above will be described with reference to FIG. 14. FIG. 14 is a sequence diagram showing the flow of information between an assistance requiring vehicle (vehicle A), an assistance non-requiring vehicle (vehicle B), the remote assistance management planner, and an operator in the remote assistance management system according to the second embodiment. This sequence diagram also represents the remote assistance management method according to the second embodiment of the present disclosure.

In the example shown in FIG. 14, the vehicle A acquires the operation state information using the sensor of the vehicle A, predicts the occurrence of an assistance request based on the acquired operation state information, calculates a predicted assistance period of the predicted assistance request (predicted potential assistance request), and calculates an evaluation value of the predicted potential assistance request. The vehicle B also acquires the operation state information using the sensor of the vehicle B, predicts the occurrence of an assistance request based on the acquired operation state information, calculates a predicted assistance period of the predicted assistance request (predicted potential assistance request), and calculates an evaluation value of the predicted potential assistance request. Each of the vehicle A and the vehicle B transmits to the remote assistance management planner the evaluation value and the predicted assistance period of the potential assistance request.

The remote assistance management planner determines whether all potential assistance requests acquired from vehicles A and B can be assigned to the available standby operators. In the event of an operator failure, the remote assistance management planner selects a vehicle instructing a change of the traveling mode from the first traveling mode to the second traveling mode in descending order of the evaluation value. In the example shown in FIG. 14, the vehicle B is selected as the target vehicle.

Then, the remote assistance management planner instructs the vehicle B selected as the target vehicle to change the traveling mode from the first traveling mode to the second traveling mode. At this time, the remote assistance management planner instructs the vehicle B to perform the control selected according to the content of the potential assistance request, in particular, the content of the influence degree as the second traveling mode.

The vehicle B changes the traveling mode from the first traveling mode to the second traveling mode as instructed by the remote assistance management planner. This avoids or delays an assistance request that would have occurred from the vehicle B in future.

On the other hand, the vehicle A then enters a situation where remote assistance is required as predicted, and transmits an assistance request to the remote assistance management planner.

The remote assistance management planner receives the assistance request from the vehicle A and determines the optimum arrangement of the operators. Then, to the operator selected as the responsibility of the vehicle A, an image showing situations of the vehicle A, which is photographed by the camera of the vehicle A, is displayed on the display.

The operator confirms the situations of the vehicle A from the image displayed on the display, and executes a remote assistance operation for the vehicle A.

As is apparent from the above description, similarly to the first embodiment, also in the remote assistance management system according to the second embodiment, when an assistance request actually occurs, the number of assistance requests in which the assistance periods overlap at the same time is suppressed to be equal to or less than the number of available standby operators. As a result, the load of the operators performing remote assistance is reduced. This makes it possible to reduce the number of operators required for remote assistance of autonomous traveling vehicles while maintaining smooth traffic by the remote assistance.

What is claimed is:

1. A remote assistance management system in communication with a plurality of autonomous traveling vehicles for letting an operator provide remote assistance in response to an assistance request from an autonomous traveling vehicle, the system comprising:
at least one memory storing at least one program; and
at least one processor coupled with the at least one memory,
wherein the at least one program is configured to cause the at least one processor to execute:
predicting, for each autonomous traveling vehicle, an occurrence of an assistance request in future based on an operation state of each autonomous traveling vehicle;
calculating a predicted assistance period for each assistance request predicted to occur; and
when more than a predetermined number of overlapping assistance requests of which predicted assistance periods overlap at the same time are predicted to occur, instructing to excess vehicles a change of a traveling mode from a first traveling mode being a normal traveling mode to a second traveling mode for avoiding or delaying an occurrence of an assistance request, the excess vehicles being autonomous traveling vehicles in excess of the predetermined number among autonomous traveling vehicles from which the overlapping assistance requests are predicted to occur.

2. The remote assistance management system according to claim 1,
wherein the at least one program is configured to cause the at least one processor to further execute:
calculating an evaluation value for each of the autonomous traveling vehicles from which the overlapping assistance requests are predicted to occur, the evaluation value being a value for determining an autonomous traveling vehicle that preferentially avoids or delays an occurrence of an assistance request; and
selecting an autonomous traveling vehicle to which a change of the traveling mode from the first traveling mode to the second traveling mode is instructed in descending order of the evaluation value.

3. The remote assistance management system according to claim 2,
wherein the calculating the evaluation value comprises:
calculating, for each the assistance request predicted to occur, a probability of an occurrence of the assistance request; and
calculating the evaluation value to a higher value for an autonomous traveling vehicle from which an assistance request with a higher occurrence probability is predicted to occur.

4. The remote assistance management system according to claim 2,
wherein the calculating the evaluation value comprises:
calculating, for each the assistance request predicted to occur, an influence degree of representing a level of an influence of a cause of the assistance request on surroundings; and
calculating the evaluation value to a higher value for an autonomous traveling vehicle from which an assistance request with a higher influence level is predicted to occur.

5. The remote assistance management system according to claim 2,
wherein the calculating the evaluation value comprises:
calculating, for each the assistance request predicted to occur, a skill of the operator required for handling the assistance request; and
calculating the evaluation value to a higher value for an autonomous traveling vehicle from which an assistance request with a higher skill is predicted to occur.

6. The remote assistance management system according to claim 2,
wherein the calculating the evaluation value comprises:
calculating, for each the assistance request predicted to occur, a handling time required for handling the assistance request; and
calculating the evaluation value to a higher value for an autonomous traveling vehicle from which an assistance request with a longer handling time is predicted to occur.

7. The remote assistance management system according to claim 2,
wherein the calculating the evaluation value comprises:
calculating, for each the assistance request predicted to occur, a margin time until the assistance request occurs; and
calculating the evaluation value to a higher value for an autonomous traveling vehicle from which an assistance request with a longer margin time is predicted to occur.

8. The remote assistance management system according to claim 1,
wherein the predicting an occurrence of an assistance request in future comprises performing prediction to a future time by a predetermined prediction time longer than a predetermined update period for predicting an occurrence of an assistance request.

9. The remote assistance management system according to claim 8,
wherein the at least one program is configured to cause the at least one processor to further execute:
arranging the operator for an autonomous traveling vehicle that is not instructed to change the traveling mode from the first traveling mode to the second traveling mode among the autonomous traveling vehicles from which the overlapping assistance requests are predicted to occur; and
updating arrangement of the operator every update period.

10. The remote assistance management system according to claim 1,
wherein the at least one memory and the at least one processor are provided on a server in communication with the plurality of autonomous traveling vehicles, and
the server is configured to:
acquire an operation state of a target autonomous traveling vehicle and operation states of other autonomous traveling vehicles other than the target autonomous traveling vehicle; and
predict an occurrence of an assistance request in future from the target autonomous traveling vehicle based on the operation state of the target autonomous traveling vehicle and the operation states of the other autonomous traveling vehicles.

11. The remote assistance management system according to claim 1,
wherein the at least one memory and the at least one processor are distributed to an on-board computer mounted on each of the plurality of autonomous traveling vehicles and a server in communication with the on-board computer, and
the on-board computer is configured to:
acquire an operation state of a target autonomous traveling vehicle on which the on-board computer is mounted using a sensor of the target autonomous traveling vehicle;
predict an occurrence of an assistance request in future from the target autonomous traveling vehicle based on the operation state of the target autonomous traveling vehicle; and
when an assistance request is predicted to occur, transmit information relating to prediction of an occurrence of the assistance request to the server.

12. A remote assistance management method for a plurality of autonomous traveling vehicles capable of receiving remote assistance from an operator, the method comprising:
predicting, for each autonomous traveling vehicle, an occurrence of an assistance request from an autonomous traveling vehicle to the operator in future based on an operation state of each autonomous traveling vehicle;
calculating a predicted assistance period for each assistance request predicted to occur; and
when more than a predetermined number of overlapping assistance requests of which predicted assistance periods overlap at the same time are predicted to occur, instructing to excess vehicles a change of a traveling mode from a first traveling mode being a normal traveling mode to a second traveling mode for avoiding or delaying an occurrence of an assistance request, the excess vehicles being autonomous traveling vehicles in excess of the predetermined number among autonomous traveling vehicles from which the overlapping assistance requests are predicted to occur.

13. A non-transitory computer-readable storage medium storing a remote assistance management program, the remote assistance management program being a program causing a computer to communicate with a plurality of autonomous traveling vehicles and let an operator provide remote assistance in response to an assistance request from an autonomous traveling vehicle,
wherein the remote assistance management program is configured to cause the computer to execute:
predicting, for each autonomous traveling vehicle, an occurrence of an assistance request in future based on an operation state of each autonomous traveling vehicle;
calculating a predicted assistance period for each assistance request predicted to occur; and
when more than a predetermined number of overlapping assistance requests of which predicted assistance periods overlap at the same time are predicted to occur, instructing to excess vehicles a change of a traveling mode from a first traveling mode being a normal traveling mode to a second traveling mode for avoiding or delaying an occurrence of an assistance request, the excess vehicles being autonomous traveling vehicles in excess of the predetermined number among autonomous traveling vehicles from which the overlapping assistance requests are predicted to occur.
